(19) United States
(12) Patent Application Publication
(10) Pub. No.: US 2019/0338643 A1
(43) Pub. Date: Nov. 7, 2019

(54) METHOD FOR MANUFACTURING A COMPONENT

(71) Applicant: Rolls-Royce Deutschland Ltd & Co KG, Blankenfelde-Mahlow (DE)

(72) Inventor: Sebastian MOTSCH, Berlin (DE)

(21) Appl. No.: 16/399,594

(22) Filed: Apr. 30, 2019

(30) Foreign Application Priority Data
May 3, 2018 (DE) 10 2018 110 632.7

(51) Int. Cl. F01D 5/02

(52) U.S. Cl. CPC F01D 5/02; F05D 2240/24; F05D 2230/40; F05D 2230/10

(57) ABSTRACT

A method for producing a structural component including the following steps: a) forming of the structural component; b) removing material from the structural component; c) thermal treatment of the structural component following step b; d) removing further material from the structural component following step c.

This application claims priority to German Patent Application DE102018110632.7 filed May 3, 2018, the entirety of which is incorporated by reference herein.

The present disclosure relates to a method for producing a structural component according to claim 1, a disc for a gas turbine engine, and a gas turbine engine.

After a structural component has been molded, mechanical stresses are regularly present inside the structural component even if there is no force applied form the outside. Such stresses are referred to as internal stresses or residual stresses. The manner in which internal stresses act in a structural component can have effects on the stability and the service life of the structural component, in particular if the structural component is a structural component that is subject to strong mechanical and/or thermal loads, e.g. a movable structural component of a gas turbine engine. With gas turbine engines, a tendency towards smaller radial dimensions of inner structural components has to be taken into account at higher rotational speeds and temperatures.

It is the objective of the present invention to improve the production of a structural component.

What is provided according to one aspect in a method for producing a structural component. The method comprises the following steps:

a) forming a structural component;
b) removing material from the structural component;
c) thermally treating the structural component following step b;
d) removing further material from the structural component following step c.

It has been shown that through this method the internal stresses of the structural component can be influenced in such a manner that the structural component has a higher structural stability and consequently a longer service life. Alternatively, the structural component can be produced with less material and thus lower weight with the service life remaining the same.

In particular, it is possible to distribute residual compressive stresses more evenly across the structural component or to be specifically stronger developed at predefined areas of the structural component, in particular at specific, e.g. highly loaded areas. This is in particular achieved by removing material prior as well as following the thermal treatment of the structural component. As material is removed the shape of the structural component is altered at least in certain sections. For example, in the steps b and/or d material is removed at an area or adjacent to an area at which stronger _{[A1]}residual compressive stresses are to be created. The material volume removed in step b can e.g. be 1/20 (a twentieth) to ½ (half), in particular 1/10 (a tenth) to a ⅓ (a third) of the material volumes removed in step b.

Optionally, the method further comprises the step of (non-destructive) inspection, in particular ultrasonic inspection of the structural component following step d. By means of ultrasonic inspection it can be determined whether the structural component has defects which may e.g. have been created during forming. Optionally, a third step of removing material from the structural component can be performed following the ultrasonic inspection.

Optionally, a calculation or simulation of an internal stress field of the structural component is further performed, in particular based on a finite element method. In this manner, it can be determined at which areas of the structural component the internal stress field can be improved.

In a further development, the removing of material in step b is performed according to a result of the calculation or simulation. In this manner, a particularly targeted and effective modification of the internal stress field of the structural component can be achieved. In one embodiment, the simulation is an iterative process simulation. Here, the internal stress field of the structural component is calculated in successive iterations. The process simulation can be carried out by means of a numerical model, in particular based on a numerical model of the formed structural component. Alternatively or additionally, also the step of forming the structural component is performed according to a result of the calculation or simulation. For example, the calculation or simulation can determine the size of a volume addition by which the structural component is expanded with respect to the predefined initial shape (in particular locally). In this case, the structural component is formed with the volume addition in step a.

Optionally, material is removed in the steps b and d at the same or at neighboring areas of the structural component.

In step b, material can be removed at a locally limited area of the structural component. Thus, the internal stress field can be influenced at neighboring areas in a targeted manner.

The forming in step a can be primary forming and/or forming. The forming can comprise forging. However, alternatively also other processes are possible, e.g. sintering or injection forming.

In at least one of step b and step d, material can be removed by cutting or post-processing. This can in particular be a rotating method. However, also other forming methods are conceivable.

Following step a and prior to step b, the structural component can have an outer shape that in one direction has a total dimension (e.g. height, width, depth or diameter), wherein in step b material is removed in this direction of the total dimension over a length that is ⅕ (a fifth) to 1/10 (a tenth) of the total dimension, in particular 1/7 (a seventh) of the total dimension.

Following step a and prior to step b, the structural component can have an outer shape that has a local dimension (e.g. the thickness of the structural component at one location of the structural component) in one direction, wherein in step b material is removed in this direction over a length that is ½ to ⅕, in particular ⅓ of the local dimension.

The structural component can be a structural component for a gas turbine engine, in particular a disc for a gas turbine engine, in particular a turbine disc or a compressor disc. With a longer service life of the structural component, the service intervals of the gas turbine engines can be enlarged. Alternatively or additionally, it is possible to save weight by using less material.

In step b, material can be removed at a radially inwardly positioned area of the structural component that is embodied as a disc.

One aspect relates to a disc for a gas turbine engine, wherein the disc is embodied for the purpose of supporting multiple airfoils, wherein the disc is manufactured or can be manufactured according to a method according to any of the preceding claims.

One aspect relates to a gas turbine engine for an aircraft, comprising a core engine that comprises a turbine, a compressor, and a core shaft that connects the turbine to the compressor; a fan positioned upstream of the core engine, wherein the fan comprises multiple fan blades; a gearbox that can be driven by the core shaft, wherein the fan can be driven by means of the gearbox with a lower speed than the core shaft, and at least one structural component, in particular a disc according to any of the embodiment described herein.

In the gas turbine engine, the turbine can be a first turbine, the compressor can be a first compressor, and the core shaft can be a first core shaft. Optionally, the core engine further comprises a second turbine, a second compressor and a second core shaft that connects the second turbine to the second compressor; and the second turbine, the second compressor and the second core shaft are arranged in such a manner that they rotate with a higher speed than the first core shaft.

As noted elsewhere herein, the present disclosure may relate to a gas turbine engine, such as for example an aircraft engine. Such a gas turbine engine may comprise a core engine comprising a turbine, a combustion device, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for gear fans that are driven via a gearbox. Accordingly, the gas turbine engine may comprise a gearbox that is driven via the core shaft, with its drive driving the fan in such a manner that it has a lower rotational speed than the core shaft. The input to the gearbox may be directly from the core shaft, or indirectly via the core shaft, for example via a spur shaft and/or gear. The core shaft may rigidly connect the turbine and the compressor, such that the turbine and the compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gearbox may be embodied to be driven by the core shaft that is configured to rotate (for example in use) at the lowest rotational speed (for example the first core shaft in the example above). For example, the gearbox may be embodied to be driven only by the core shaft that is configured to rotate (for example in use) at the lowest rotational speed (for example only by the first core shaft, and not the second core shaft, in the example above). Alternatively, the gearbox may be embodied to be driven by one or multiple shafts, for example the first and/or second shaft in the above example.

In a gas turbine engine as described and/or claimed herein, a combustion device may be provided axially downstream of the fan and the compressor (or the compressors). For example, the combustion device may be located directly downstream of the second compressor (for example at the exit thereof), if a second compressor is provided. By way of further example, the flow at the exit to the combustor may be provided to the inlet of the second turbine, if a second turbine is provided. The combustion device may be provided upstream of the turbine(s).

The or each compressor (for example the first compressor and the second compressor according to the above description) may comprise any number of stages, for example multiple stages. Each stage may comprise a row of rotor blades and a row of stator vanes, which may be variable stator vanes (i.e. in that their angle of incidence may be variable). The row of rotor blades and the row of stator vanes may be axially offset with respect to each other.

The or each turbine (for example the first turbine and second turbine according to the above description) may comprise any number of stages, for example multiple stages. Each stage may comprise a row of rotor blades and a row of stator vanes. The row of rotor blades and the row of stator vanes may be axially offset with respect to each other.

Each fan blade may have a radial span width extending from a root (or hub) at a radially inner gas-washed location, or from a 0% span position to a tip with a 100% span width. Here, the ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in a closed range bounded by any two values in the previous sentence (i.e., the values may represent upper or lower bounds). These ratios may generally be referred to as the hub-to-tip ratio. The radius at the hub and the radius at the tip may both be measured at the leading edge (or the axially forward most edge) of the blade. The hub-to-tip ratio refers, of course, to the gas-washed portion of the fan blade, i.e. the portion that is located radially outside any platform.

The radius of the fan may be measured between the engine centerline and the tip of a fan blade at its leading edge. The fan diameter (which may generally be twice the radius of the fan) may be greater than (or on the order of) any of: 250 cm (about 100 inches), 260 cm, 270 cm (about 105 inches), 280 cm (about 110 inches), 290 cm (about 115 inches), 300 cm (about 120 inches), 310 cm, 320 cm (about 125 inches), 330 cm (about 130 inches), 340 cm (about 135 inches), 350 cm, 360 cm (about 140 inches), 370 cm (about 145 inches), 380 (about 150 inches) cm or 390 cm (about 155 inches). The fan diameter may be in a closed range bounded by any two of the values in the previous sentence (i.e. the values may represent upper or lower bounds).

The rotational speed of the fan may vary during operation. Generally, the rotational speed is lower for fans with a larger diameter. Purely by way of non-limitative example, the rotational speed of the fan at cruising conditions may be less than 2500 rpm, for example less than 2300 rpm. Purely by way of further non-limitative example, the rotational speed of the fan at cruising conditions for an engine having a fan diameter in the range of from 250 cm to 300 cm (for example 250 cm to 280 cm) may be in the range from 1700 rpm to 2500 rpm, for example in the range of between 1800 rpm to 2300 rpm, for example in the range of between 1900 rpm to 2100 rpm. Purely by way of further non-limitative example, the rotational speed of the fan at cruising conditions for an engine having a fan diameter in the range of between 320 cm to 380 cm may be in the range of between 1200 rpm to 2000 rpm, for example in the range of between 1300 rpm to 1800 rpm, for example in the range of between 1400 rpm to 1600 rpm.

In use of the gas turbine engine, the fan (with the associated fan blades) rotates about a rotational axis. This rotation results in the tip of the fan blade moving with a velocity Uₜᵢₚ. The work done by the fan blades on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as the fan tip radius at the leading edge multiplied by the angular speed). The fan tip loading at cruising conditions may be greater than (or on the order of) any of: 0.3, 0.31, 0.32, 0.33, 0.34, 0.35, 0.36, 0.37, 0.38, 0.39 or 0.4 (with all units in this paragraph being Jkg⁻¹K⁻¹ /(ms⁻¹)²). The fan tip loading may be in a closed range bounded by any two of the values in the previous sentence (i.e. the values may represent upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruising conditions. In some arrangements, the bypass ratio may be greater than (or on the order of): 10, 10.5, 11, 11.5, 12, 12.5, 13, 13.5, 14, 14.5, 15, 15.5, 16, 16.5, or 17. The bypass ratio may be in a closed range bounded by any two of the values in the previous sentence (i.e. the values may represent upper or lower bounds). The bypass duct may be substantially annular. The bypass duct may be radially outside the core engine. The radially outer surface of the bypass duct may be defined by a nacelle and/or a fan housing.

The overall pressure ratio of a gas turbine engine as described and/or claimed herein may be defined as the ratio of the stagnation pressure upstream of the fan to the stagnation pressure at the exit of the highest-pressure compressor (before entry into the combustion device). By way of non-limitative example, the overall pressure ratio of a gas turbine engine as described and/or claimed herein at cruising speed may be greater than (or on the order of): 35, 40, 45, 50, 55, 60, 65, 70, 75. The overall pressure ratio may be in a closed range bounded by any two of the values in the previous sentence (i.e. the values may represent upper or lower bounds).

Specific thrust of an engine may be defined as the net thrust of the engine divided by the total mass flow through the engine. At cruising conditions, the specific thrust of an engine as described and/or claimed herein may be less than (or on the order of): 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in a closed range bounded by any two of the values in the previous sentence (i.e. the values may represent upper or lower bounds). Such engines may be particularly efficient as compared to conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of): 160 kN, 170 kN, 180 kN, 190 kN, 200 kN, 250 kN, 300 kN, 350 kN, 400 kN, 450 kN, 500 kN, or 550 kN. The maximum thrust may be in a closed range bounded by any two of the values in the previous sentence (i.e. the values may represent upper or lower bounds). The thrust referred to above may be the maximum net thrust at standard atmospheric conditions at sea level plus 15° C. (ambient pressure 101.3 kPa, temperature 30° C.), with the engine being static.

In use, the temperature of the flow at the entry to the high-pressure turbine may be particularly high. This temperature, which may be referred to as TET, may be measured at the exit to the combustion device, for example immediately upstream of the first turbine vane, which itself may be referred to as a nozzle guide vane. At cruising speed, the TET may be at least (or on the order of): 1400 K, 1450 K, 1500 K, 1550 K, 1600 K or 1650 K. The TET at cruising speed may be in a closed range bounded by any two of the values in the previous sentence (i.e. the values may represent upper or lower bounds). The maximum TET in use of the engine may be, for example, at least (or on the order of): 1700 K, 1750 K, 1800 K, 1850 K, 1900 K, 1950 K or 2000 K. The maximum TET may be in a closed range bounded by any two of the values in the previous sentence (i.e. the values may represent upper or lower bounds). The maximum TET may occur, for example, at a high thrust condition, for example at a maximum take-off (MTO) condition.

A fan blade and/or aerofoil portion of a fan blade as described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fiber. By way of further example, at least a part of the fan blade and/or aerofoil may be manufactured at least in part from a metal, such as a titanium based metal or an aluminum based material (such as an aluminum-lithium alloy) or a steel based material. The fan blade may comprise at least two regions that are manufactured by using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fiber or aluminum based body (such as an aluminum lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be present in the form of a dovetail that may be inserted into a corresponding slot in the hub/disc and/or may engage with the same in order to fix the fan blade to the hub/disc. By way of further example, the fan blades may be formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow for the exit area of the bypass duct to be varied during operation. The general principles of the present disclosure may apply to engines with or without a VAN.

The fan of a gas turbine as described and/or claimed herein may have any desired number of fan blades, for example 16, 18, 20, or 22 fan blades.

As used herein, cruising conditions may refer to the cruising conditions of an aircraft to which the gas turbine engine is attached. Such cruising conditions may be conventionally defined as the conditions at mid-cruise, for example the conditions experienced by the aircraft and/or engine at the midpoint (in terms of time and/or distance) between top of climb and start of descend.

Purely by way of example, the forward speed at the cruising condition may be any point in the range from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85, or in the range from 0.8 to 0.85. Any speed within these ranges may be the cruising condition. For some aircrafts, the cruising conditions may be outside these ranges, for example below Mach 0.7 or above Mach 0.9.

Purely by way of example, the cruising conditions may correspond to standard atmospheric conditions at an altitude that is in the range from 10000 m to 15000 m, for example in the range from 10000 m to 12000 m, for example in the range from 10400 m to 11600 m (around 38000 ft), for example in the range from 10500 m to 11500 m, for example in the range from 10600 m to 11400 m, for example in the range from 10700 m (around 35000 ft) to 11300 m, for example in the range from 10800 m to 11200 m, for example in the range from 10900 m to 11100 m, for example on the order of 11000 m. The cruising conditions may correspond to standard atmospheric conditions at any given altitude in these ranges.

Purely by way of example, the cruising conditions may correspond to the following: a forward Mach number of 0.8; a pressure of 23000 Pa; and a temperature of −55° C.

As used anywhere herein, “cruise” or “cruising conditions” may refer to the aerodynamic design point. Such an aerodynamic design point (or ADP) may correspond to the conditions (comprising, for example, one or more of the Mach Number, environmental conditions and thrust requirement) in which the fan is designed to operate. This may mean, for example, the conditions at which the fan (or the gas turbine engine) is designed to have optimum efficiency.

During operation, a gas turbine engine as described and/or claimed herein may operate at the cruising conditions defined elsewhere herein. Such cruising conditions may be determined by the cruising conditions (for example the mid-cruising conditions) of an aircraft to which at least one (for example two or four) of the gas turbine engine(s) may be mounted in order to provide propulsive thrust.

The skilled person will appreciate that, except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

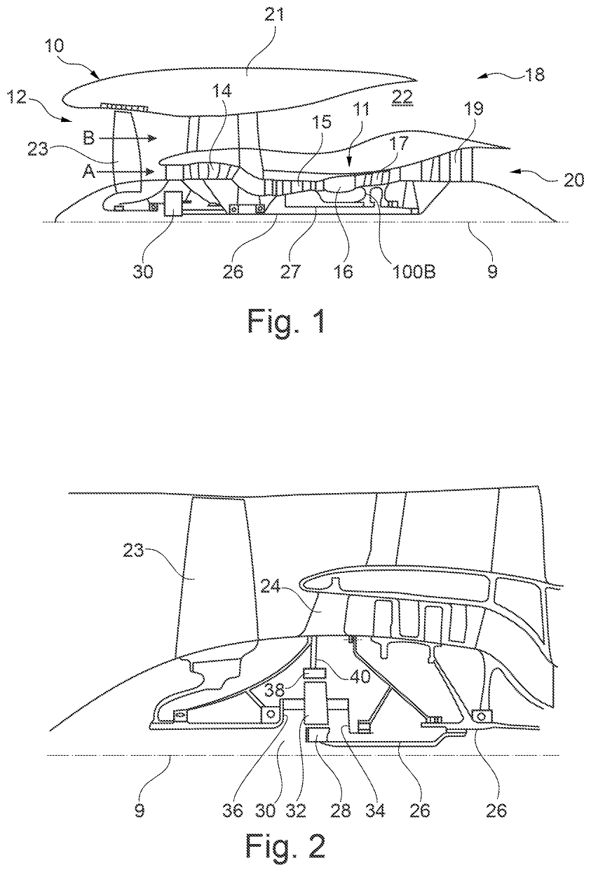

FIG. 1 shows a sectional side view of a gas turbine engine;

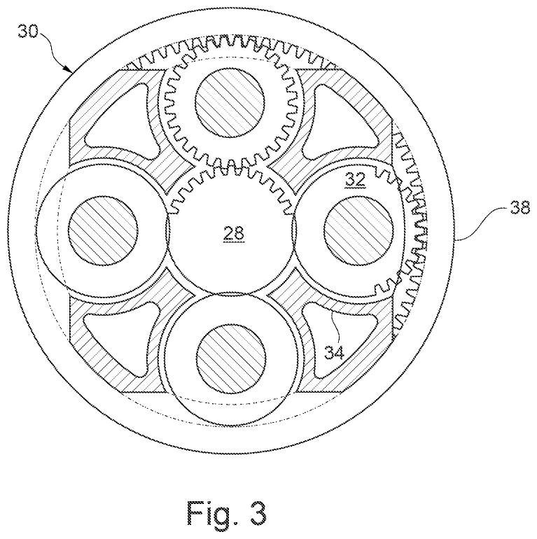

FIG. 2 an enlarged sectional side view of an upstream section of a gas turbine engine;

FIG. 3 shows a partial cut-away view of a gearbox for a gas turbine engine;

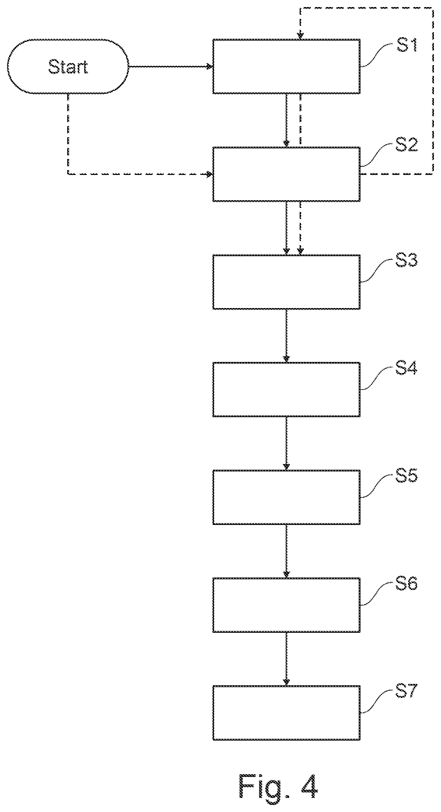

FIG. 4 shows a method for producing a structural component;

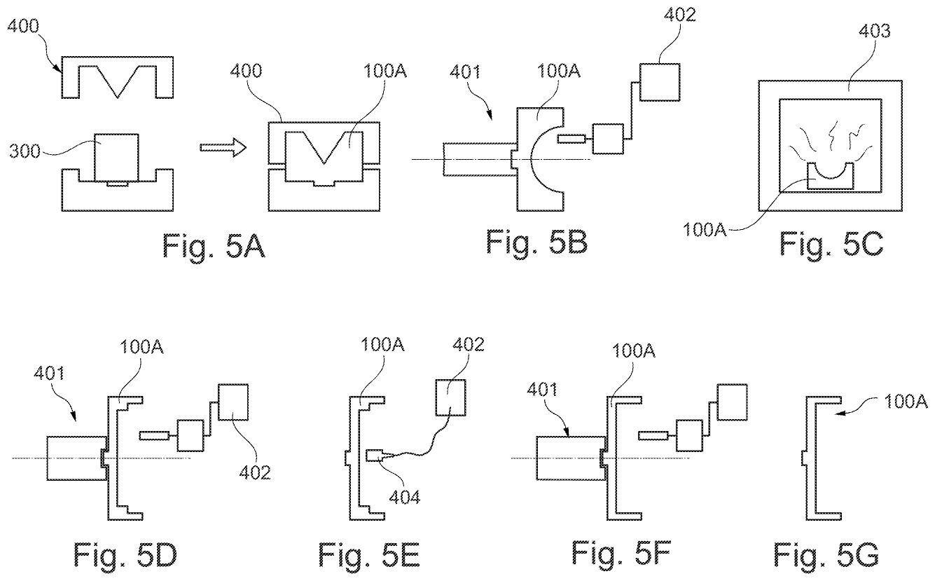

FIG. 5A to 5G show a structural component during multiple processing steps in the method according to FIG. 4;

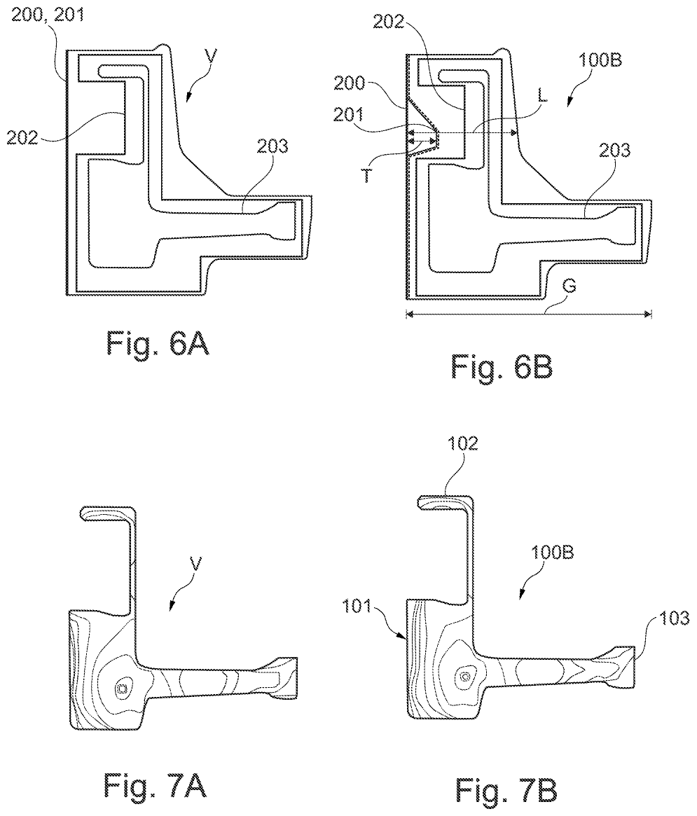

FIG. 6A shows a cross section through a comparative structural component in multiple phases of manufacturing in a comparative method;

FIG. 6B shows a cross section through a structural component in multiple phases of manufacturing according to a method according to FIG. 4;

FIG. 7A shows a cross section through the finished comparative structural component according to FIG. 6A with indicated isobars;

FIG. 7B shows a cross section through the finished structural component according to FIG. 6B with indicated isobars;

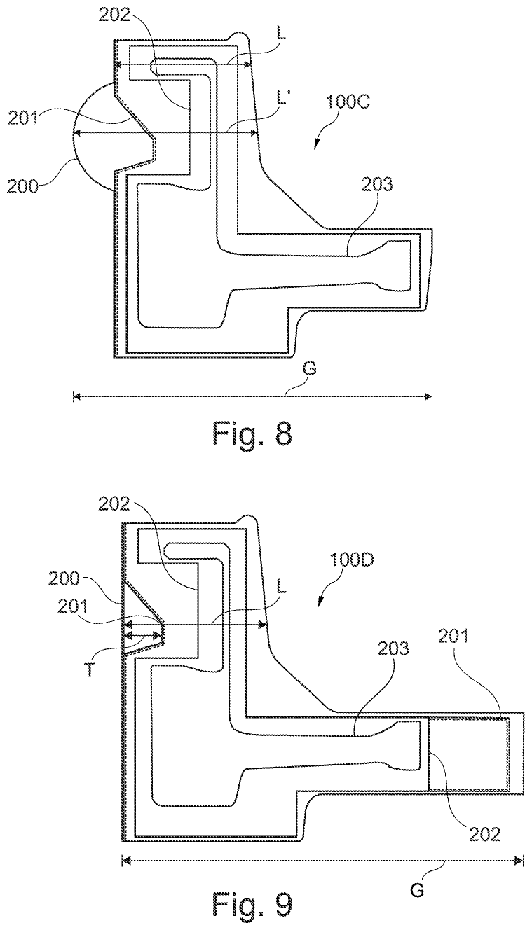

FIG. 8 shows a cross section through a structural component in multiple phases of manufacturing according to a method according to FIG. 4; and

FIG. 9 shows a cross section through a structural component in multiple phases of manufacturing according to the method according to FIG. 4.

FIG. 1 shows a gas turbine engine 10 having a principal rotational axis 9. The gas turbine engine 10 comprises an air intake 12 and a fan 23 that generates two airflows: a core airflow A and a bypass airflow B. The core engine 11 comprises, as viewed in the axial flow direction, a low-pressure compressor 14, a high-pressure compressor 15, combustion device 16, a high-pressure turbine 17, a low-pressure turbine 19 and a core thrust nozzle 20. An engine nacelle 21 surrounds the gas turbine engine 10 and defines the bypass channel 22 and a bypass thrust nozzle 18. The bypass airflow B flows through the bypass channel 22. The fan 23 is attached at the low-pressure turbine 19 via a shaft 26 and an epicyclic planetary gearbox 30, and is driven by the low-pressure turbine 19.

During operation, the core airflow A is accelerated and compressed by the low-pressure compressor 14 and guided into the high-pressure compressor 15, where further compression takes place. The air that is discharged from the high-pressure compressor 15 in a compressed state is directed into the combustion device 16 where it is mixed with fuel and combusted. The resulting hot combustion products are then propagated through the high-pressure and the low-pressure turbine 17, 19, thus driving it before being discharged through the nozzle 20 for providing a certain thrust. The high-pressure turbine 17 drives the high-pressure compressor 15 via a suitable interconnecting shaft 27. The fan 23 usually provides the greatest portion of the propulsive thrust. The epicyclic planetary gearbox 30 is a reduction gear.

An exemplary arrangement for a geared fan gas turbine engine 10 is shown in FIG. 2. The low pressure turbine 19 (see FIG. 1) drives the shaft 26, which is coupled to a sun gear 28 of the epicyclic planetary gearbox 30. Located radially outwardly of the sun gear 28 and intermeshing therewith are multiple planetary gears 32 that are coupled with each other by a planet carrier 34. The planet carrier 34 guides the planetary gears 32 in such a manner that they rotate synchronously around the sun gear 28 whilst enabling each planet gear 32 to rotate about its own axis. Via linkages 36, the planet carrier 34 is coupled to the fan 23 in such a manner that it causes it to rotate about the rotational axis 9. An external gear or ring gear 38 that is coupled via linkages 40 to a stationary supporting structure 24 is located radially outside of the planetary gears 32 and intermeshes therewith.

Note that the terms “low-pressure turbine” and “low-pressure compressor” as used herein may be taken to refer to the turbine stage with the lowest pressure or the compressor stage with the lowest pressure (i.e., not including the fan 23) and/or refer to the turbine and compressor stage that are connected by the interconnecting shaft 26 with the lowest rotational speed in the engine (i.e., not including the gearbox output shaft that drives the fan 23). In some documents, a “low-pressure turbine” and a “low-pressure compressor” referred to herein may alternatively also be known as an “intermediate-pressure turbine” and an “intermediate-pressure compressor”. Where such alternative nomenclature is used, the fan 23 may be referred to as a first or lowest pressure stage.

The epicyclic planetary gearbox 30 is shown by way of example in greater detail in FIG. 3. The sun gear 28, planetary gears 32 and the ring gear 38 respectively have teeth at their circumference to facilitate intermeshing with the other gears. However, for reasons of clarity, only exemplary portions of the teeth are illustrated in FIG. 3. Here, four planetary gears 32 are illustrated, although it will be apparent to the person skilled in the art that more or fewer planetary gears 32 may be provided within the scope of the claimed invention. Practical applications of a planetary epicyclic gearbox 30 generally comprise at least three planetary gears 32.

The epicyclic planetary gearbox 30 illustrated by way of example in FIGS. 2 and 3 is a planetary gearbox in which the planetary carrier 34 is connected to an output shaft via linkages 36. However, it is also possible to use any other suitable type of a planetary gearbox 30. By way of further example, the planetary gearbox 30 may comprise a star arrangement, in which the planet carrier 34 is supported in a fixed manner, with the ring gear (or external gear) 38 being allowed to rotate. In such an arrangement, the fan 23 is driven by the ring gear 38. By way of further alternative example, the gearbox 30 may be a differential gearbox in which the ring gear 38 as well as the planet carrier 34 are allowed to rotate.

It will be obvious that the arrangement shown in FIGS. 2 and 3 serves merely as an example, and the scope of the present disclosure also comprises various alternatives. Purely by way of example, any suitable arrangement may be used for arranging the gearbox 30 in the gas turbine engine 10 and/or for connecting the gearbox 30 to the gas turbine engine 10. By way of further example, the connections (such as the linkages 36, 40 in the example according to FIG. 2) between the gearbox 30 and other parts of the gas turbine engine 10 (such as the input shaft 26, the output shaft and the stationary support structure 24) may have any certain degree of stiffness or flexibility. By way of further example, any suitable arrangement of the bearings between rotating and stationary parts of the gas turbine engine 10 (for example between the input and output shafts of the gearbox 30 and the fixed structures, such as for example the gearbox casing) may be used, and the disclosure is not limited to the exemplary arrangement of FIG. 2. For example, where the gearbox 30 has a star arrangement (described above), the person skilled in the art would readily understand that the arrangement of output and support linkages and bearing locations would typically be different from that shown in FIG. 2.

Accordingly, the present disclosure extends to a gas turbine engine 10 having any arrangement of gearbox styles (for example star arrangement or planetary arrangements), support structures, input and output shaft arrangement, and bearing locations.

Optionally, the gearbox may drive additional and/or alternative components (e.g. the intermediate-pressure compressor and/or a booster compressor).

Other gas turbine engine 10 to which the present disclosure may be applied may have alternative configurations. For example, such engines may have an alternative number of compressors and/or turbines and/or an alternative number of interconnecting shafts. By way of further example, the gas turbine engine 10 shown in FIG. 1 has a split flow nozzle 20, 22, meaning that the flow through the bypass channel 22 has its own nozzle that is separate from and arranged radially outside of the engine core nozzle 20. However, this is not to be taken in a limiting manner, and any aspect of the present disclosure may also apply to engines in which the flow through the bypass channel 22 and the flow through the core 11 is intermixed or combined in front of (or upstream of) a single nozzle which may be referred to as a mixed flow nozzle. One or both nozzles may have a fixed or variable cross section (independently of whether a mixed or a partial flow is present). Whilst the example described herein relates to a turbofan engine, the disclosure may apply, for example, to any type of gas turbine engine, such as an engine with an open rotor (in which the fan stage is not surrounded by an engine nacelle) or to a turboprop engine, for example.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

FIG. 4 illustrates the individual steps of a method for producing a structural component 100A. In the subsequent description of this method, the FIGS. 5A to 5G are additionally referred to, showing the structural component 100A in multiple steps of manufacturing.

In a first step S1, the structural component 100A is formed. Here, different methods are possible, in particular primary forming and/or forming. In the example shown in FIG. 5A, a forging material 300 is formed in a forging device 400. For easier reference, the product that is produced in this process is referred to as the structural component 100A from this step on, even if this final shape will only be reached after multiple further method steps. Following forming, internal stresses (inner stresses, residual stresses) are present inside the structural component 100A. The manifestations of the internal stresses have consequences for the mechanical properties and the stability of the structural component 100A.

In a further step S2, which can also be performed prior to the previously described step S1, a calculation or simulation of an internal stress field of the structural component 100A is performed (e.g. based on the finite element method). The calculation/simulation can comprise an optimization algorithm. The simulation can comprise an iterative process simulation. The calculation or simulation can be based on a model, in particular a numerical model. The calculation or simulation can be performed by means of a computer 402 (see in particular FIG. 5B). Here, that internal stress field may for example be calculated or simulated that the structural component 100A would have if a certain amount of material was removed at a certain position of the structural component. Here, multiple variants can be calculated/simulated, and respectively that variant or those variants can be selected in multiple iterations that has/have the best internal stress field. The best internal stress field is e.g. an internal stress field that is as homogenous as possible, and/or an internal stress field that [has] a compression stress at areas of the structural component 100A that are subjected to tension during the later use of the structural component 100A. Alternatively or additionally, it is also possible to calculate/simulate variants that have a volume addition with respect to an initial shape (in particular locally). In this case, the structural component is formed in step S1 with the volume addition (and the step S2 is performed prior to step S1, as is illustrated by the dashed lines in FIG. 4).

An input parameter of the simulation (apart from a geometry and a material of the structural component, e.g. a steel, nickel or titanium alloy) can be the indication of an area that is supposed to have increased residual compressive stresses (or alternatively tensile residual stresses, depending on the requirement). The simulation can further comprise a service life calculation. The result of the simulation may e.g. be an indication as to how much material has to be removed at what position of the structural component 100A, and/or how large the initial shape of the structural component 100A has to be planned (e.g. 100A according to FIG. 5A).

To influence the internal stresses (more precisely, the internal stress field) in the structural component 100A, material is removed from the structural component 100A in one subsequent step S3. The material can be removed at a locally limited area of the structural component 100A, e.g. only at one side or only a portion of a side of the structural component 100A. According to FIG. 5B, the material is removed by means of lathe 401 (alternatively, other types of machining are conceivable). The structural component 100A is attached at a drive and rotated by means of the drive. A blade or the like is moved, in a manner controlled by a computer 402, to the rotating structural component 100A, so that material of the structural component 100A is removed. The computer 402 can select the lathe 401 depending on the result of the calculation or simulation.

In a basic subsequent step S4, the structural component 100A is thermally treated. This may for e.g. be performed in a furnace 403 (see FIG. 5C). In an exemplary structural component made of steel, a thermal treatment can be performed as follows. In a warm-up period of e.g. 4 hours, the structural component is heated up to e.g. 600° C. This temperature may e.g. be maintained for 6 hours. Subsequently, cooling e.g. with a rate of 35° C. per hour is performed. Other materials may e.g. be heated up to such a temperature that they begin to plastically flow. Through the thermal treatment, the internal stresses of the structural component 100A can be reduced.

Following the thermal treatment in step S4, material is again removed in a subsequent step S5. According to FIG. 5D, this can again be carried out with a lathe 401. Here, too, the removing of material can occur depending on a result of the simulation, e.g. through selection by a computer 402. The material is optionally removed at a location of the structural component 100A that adjoins the area at which material had already been removed in the previous step S3.

Optionally, the structural component 100A is ultrasonically inspected in a step S6 following step S5. According to FIG. 5E, this can be performed with an ultrasound testing device 404. The ultrasound testing device can be coupled to the computer 402 to analyze the measuring results of the ultrasound testing device 404. In an ultrasonic inspection e.g. material defects can be detected. Structural components 100A in which a material defect has been detected, can be taken out or reworked, e.g. by once more performing one or multiple of the steps S3 to S5 (in that case, inspection optionally takes place in a renewed step S6).

In an optional subsequent step S7, material is again removed from the structural component 100A (see FIG. 5F), optionally at a location at the structural component 100A that adjoins an area at which material has already been removed in a previous step S3, S5. In this step, the final geometry of the structural component 100A can be created, if this has not already happened before.

FIG. 5G shows the finished structural component 100A, which in the present case is the ring gear 38 of the gearbox 30 according to FIG. 3, by way of example.

FIG. 6A shows a comparative structural component V that will be explained in more detail in the following.

FIG. 6B shows multiple contours of a structural component 100B during manufacturing in the method according to FIG. 4. This structural component 100B is a disc of the gas turbine engine 10 according to FIGS. 1 and 2, concretely a disc of the high-pressure turbine 17 (see FIG. 1). The structural component 100B is configured for supporting vanes or blades at an outer circumference. The structural component 100B has an inner passage opening (for receiving the shaft 26). FIG. 6B shows the structural component 100B in the cross section, wherein only a half is shown. The edge of the structural component 100B that is located at the left in FIG. 6B delimits the passage opening.

Following the step S1 of forming the structural component 100B (in the present example by means of forging), the structural component 100B has a shape that is referred to as the black forging shape 200 here. After removing material in step S3, the structural component 100B has a shape that is referred to as the thermal treatment shape 201 here. As can be seen in FIG. 6B, material has been locally removed here in the area of the passage opening, thus forming an (inner circumferential) groove, for example. The thermal treatment shape 201 differs from the black forging shape 200. The thermal treatment shape 201 has at least one local deviation from the black forging shape 200. In the present example, the thermal treatment shape 201 has an indentation that had not been formed in the black forging shape 200. By removing material in step S3, a curvature is for example introduced or reinforced in a surface of the structural component 100B. Alternatively or additionally, a curvature is removed from the surface of the structural component 100B, or is reduced.

The black forging shape 200 of the structural component 100B has a total dimension G (with respect to the sections of the structural component 100B that are connected to each other in the cross section along the direction of this total dimension G). As shown in FIG. 6B, the total dimension G can be measured the in radial direction of the structural component 100B that is embodied as a disc.

At the position at which material is removed in step S3 (prior to thermal treatment in step S4), the black forging shape 200 of the structural component 100B has a local dimension L that is parallel to the total dimension G. In step S3, a material volume up to a depth T (in parallel to the total dimension G and to the local dimension L) is removed from the structural component 100B at this position. The depth T can e.g. be 1/10 to ½ of the total dimension G, in particular 1/9 to ⅕, in particular 1/7. Optionally, the depth T is ¼ to ½ of the local dimension L, in particular ⅓.

In step S3 (prior to thermal treatment in step S4), material can e.g. be removed from the structural component 100B at such a position at which the black forging shape 200 and a testing shape 202 and/or a final shape 203 differ from each other most strongly. In other words, material can be removed prior to thermal treatment at a location where particularly much, in particular the largest amount of material has to be removed until the finished structural component is formed.

The thermal treatment shape 201 has a smaller volume than the black forging shape 200. Material is again removed after the thermal treatment in the step S4. In that case, the structural component has the testing shape 202. The testing shape 202 has a smaller volume than the thermal treatment shape 201.

Following ultrasonic inspection, material is again removed, so that the structural component 100B has the final shape 203.

FIG. 7A shows the finished comparative structural component V.

FIG. 7B shows the structural component 100B with the final shape 203. The finished structural component 100B has a flange 102 and an outer circumference 103 regarding the passage opening 101 auf. Further, isobars with respectively constant internal stress are indicated in FIG. 7.

FIG. 6A shows the contours of the comparative structural component V which is thermally treated directly after forming. In this structural component, the black forging shape 200 and the thermal treatment shape 201 are thus identical. FIG. 7A shows the final shape of this comparative structural component V, with isobars are being indicated.

As a comparison of FIGS. 7A and 7B shows, the structural component 100B shown in FIG. 7B which has been manufactured according to the method according to FIG. 4, has particularly evenly distributed internal stresses in the area of the passage opening 101, more evenly than in the comparative structural component V. In addition, it has been shown that the internal stresses in the area of the passage opening 101 and of the flange 102 are stronger than compression stresses. These compression stresses can be compensated by tensile stresses performed externally during use of the structural component 100B in the gas turbine engine 10. In this manner, the structural component 100B can have a longer service life.

FIG. 8 shows a structural component 100C which is formed with a material addition in step S1. In this case, the black forging shape 200 has a reinforced local dimension L′ as compared to the local dimension L of an adjacent area. The area with the reinforced local dimension L′ adjoins the area at which material is removed in step S3 (before thermal treatment). The difference between the reinforced local dimension L′ and the local dimension L of the adjacent area can e.g. be 1/10 to ½ of the total dimension G, in particular 1/9 to ⅕, in particular 1/7. Alternatively, the local dimension L′ can be larger by 1/7 than a local dimension at the same position of an initial shape (prior to a corresponding calculation or simulation).

FIG. 9 shows a structural component 100D which is formed with a material addition in step S1_similar to the structural component 100C according to FIG. 8. Compared to an initial shape (e.g. the black forging shape 200 according to FIG. 6A or 6B), the black forging shape 200 of the structural component 100D has a (local) volume addition. Here, the volume addition is provided in the area of the outer circumference 103 of the structural component 100D (at which blades can later be attached). The size of this volume addition represents the result of a calculation and/or simulation in which in particular the internal stress field of the structural component 100D has been optimized. Thus, the total dimension G is enlarged by for example ⅙ to ⅓, e.g. by ¼ of the original total dimension with respect to the original total dimension. Here, the thermal treatment shape 201 is also locally enlarged with respect to the initial shape (e.g. the thermal treatment shape of the comparative structural component V). Optionally, the testing shape 202 is unchanged with respect to the testing shape of the comparative structural component V according to FIG. 6A. The thermal treatment shape 201 has a smaller volume than the black forging shape 200. The testing shape 202 has a smaller volume than the thermal treatment shape 201. The final shape 203 has a smaller volume than the testing shape 202.

Alternatively to the described simulation, empirical values can be included. Further, test measurements can be taken at structural components in which material is to be removed in different amounts or at different locations in step S3. The material can then be removed in steps S3, S5 and/or S7 according to one of these structural components. Optionally, simulation or test measurements is/are performed with a structural component size, and the results of the simulation or test measurements are extrapolated to another structural component size. The method according to FIG. 4 is then performed with these results (optionally without step S2).

It is to be understood that the invention is not limited to the embodiments described herein and that various modifications and improvements can be realized without departing from the concepts described herein. Except where they are mutually exclusive, any of the features can be used separately or in combination with any other features, and the disclosure extends to all combinations and sub-combinations of one or multiple features described herein, and includes the same.

### PARTS LIST

9 main rotational axis
10 gas turbine engine
11 core engine
12 air intake
14 low-pressure compressor
15 high-pressure compressor
16 combustion device
17 high-pressure turbine
18 bypass thrust nozzle
19 low-pressure turbine
20 core thrust nozzle
21 engine nacelle
22 bypass channel
23 fan
24 stationary support structure
26 shaft
27 connecting shaft
28 sun gear
30 gearbox
32 planetary gears
34 planetary carrier
36 linkage
38 ring gear
40 linkage
100A-100D structural component
101 passage opening
102 flange
103 outer circumference
200 black forging shape
201 thermal treatment shape
202 testing shape
203 final shape
300 forging material
400 forging device
401 lathe
402 computer
403 furnace
404 ultrasound testing device
A core airflow
B bypass airflow
G total dimension
L local dimension
L′ reinforced local dimension
T depth
V comparative structural component

1. A method for producing a structural component with the following steps:
a) forming the structural component;
b) removing material from the structural component;
c) thermal treatment of the structural component following step b;
d) removing further material from the structural component following step c.

2. The method according to claim 1, further comprising the following step:
e) non-destructive inspection, in particular ultrasonic inspection, of the structural component following step d.

3. The method according to claim 1, wherein further a calculation or simulation of an internal stress field of the structural component is performed.

4. The method according to claim 3, wherein the removing of material in step b is performed according to a result of the calculation or simulation.

5. The method according to claim 1, wherein material is removed at the same or at neighboring areas of the structural component in steps b and d.

6. The method according to claim 1, wherein material is removed at a locally limited area of the structural component in step b.

7. The method according to claim 1, wherein the forming in step a comprises forging.

8. The method according to claim 1, wherein material is removed by cutting in at least one of step b and step d.

9. The method according to claim 1, wherein, following step a and prior to step b, the structural component has an outer shape that has a total dimension (G) in one direction, wherein in step b material is removed in this direction over a length that is a seventh of the total dimension (G).

10. The method according to claim 1, wherein, following step a and prior to step b, the structural component has an outer shape that has a local dimension (L) in one direction, wherein in step b material is removed in this direction over a length that is a third of the local dimension (L).

11. The method according to claim 1, wherein the finished structural component is a disc for a gas turbine engine.

12. The method according to claim 11, wherein in step b material is removed at a radially inwardly positioned area of the structural component.

13. A disc for a gas turbine engine, wherein the disc is embodied for the purpose of supporting multiple airfoils, wherein the disc is produced or can be produced according to a method according to claim 1.

14. A gas turbine engine for an aircraft, comprising:
a core engine that comprises a turbine, a compressor and a core shaft that connects the turbine to the compressor;
a fan that is positioned upstream of the core engine, wherein the fan comprises multiple fan blades;
a gearbox that can be driven by the core shaft, wherein the fan can be driven by means of the gearbox with a lower speed than the core shaft, and
at least one disc according to claim 13.

15. The gas turbine engine according to claim 14, wherein:
the turbine is a first turbine, the compressor is a first compressor and the core shaft is a first core shaft;
the core engine further comprises a second turbine, a second compressor and a second core shaft that connects the second turbine to the second compressor; and
the second turbine, the second compressor and the second core shaft are arranged in such a manner that they rotate with a higher speed than the first core shaft.
